(19) United States
(12) Patent Application Publication
(10) Pub. No.: US 2026/0302885 A1
(43) Pub. Date: Oct. 1, 2026

(54) PUMP APPARATUS AND TURBINE POWER GENERATOR

(71) Applicant: EBARA CORPORATION, Tokyo (JP)

(72) Inventors: Tetsuji KASATANI, Tokyo (JP); Kei WATAJI, Tokyo (JP); Mitsutaka IWAMI, Tokyo (JP); Hayato IKEDA, Tokyo (JP); Masaaki MIURA, Tokyo (JP); Hyuga KIKUCHI, Tokyo (JP); Akihiro HARA, Tokyo (JP)

(21) Appl. No.: 19/474,848

(22) PCT Filed: Apr. 8, 2024
(86) PCT No.: PCT/JP2024/014313

§ 371 Date: Oct. 13, 2025

(30) Foreign Application Priority Data
Apr. 20, 2023 (JP) 2023-069339

(51) Int. Cl. H02K 7/18; F04D 7/00

(52) U.S. Cl. CPC H02K 7/1823; F04D 7/00

(57) ABSTRACT

The pump apparatus for delivering liquefied gas includes a suction container and a pump. The suction container has a vacuum insulation container and a vacuum insulation lid. The pump is disposed in a pump chamber formed in the vacuum insulation container. A gas-layer space for forming a gas insulation layer made of the boil-off gas is formed between an inner surface of the vacuum insulation container and an outer surface of a hermetic structure of the vacuum insulation lid. The gas-layer space s in communication with the pump chamber.

### TECHNICAL FIELD

The present invention relates to a pump apparatus for delivering liquefied gas, such as liquid hydrogen, liquid nitrogen, liquefied ammonia, liquefied natural gas, liquefied ethylene gas, or liquefied petroleum gas, and a turbine power generator for use in a liquefaction plant for liquefied gas, and more particularly to a pump apparatus having a pump disposed in a suction container, and a turbine power generator having a turbine machine disposed in a suction container.

### BACKGROUND ART

Natural gas is widely used for thermal power generation and used as a raw material for chemicals. Furthermore, hydrogen is expected to be an energy that does not generate carbon dioxide that causes global warming. Applications of hydrogen as an energy include fuel cell and turbine power generation. Natural gas and hydrogen are in a gaseous state at normal temperature, and therefore natural gas and hydrogen are cooled and liquefied for their storage and transportation. Liquefied gas, such as liquefied natural gas (LNG) or liquid hydrogen, is temporarily stored in a liquefied-gas storage tank and then delivered to a power plant, factory, or the like by a pump.

FIG. 17 is a schematic diagram showing a conventional example of a pump apparatus for delivering liquefied gas. A pump 500 is installed in a vertical suction container 505, which is coupled to a liquefied-gas storage tank (not shown) in which the liquefied gas is stored. The liquefied gas is introduced into the suction container 505 through a suction port 501, and the entire pump 500 is immersed in the liquefied gas. Therefore, the pump 500 is a submergible pump that can operate in the liquefied gas. When the pump 500 is in operation, the liquefied gas is sucked into a suction port 500a of the pump 500 and discharged by the pump 500 through a discharge port 502.

Most of the liquefied gas in the suction container 505 is in a liquid state. However, a small amount of heat from a surrounding atmosphere is transferred to the liquefied gas through a wall of the suction container 505. As a result, a part of the liquefied gas is gasified to form boil-off gas (BOG). Therefore, a boil-off gas discharge port 503 is coupled to the suction container 505 for discharging the boil-off gas. The boil-off gas in the suction container 505 is discharged from the suction container 505 through the boil-off gas discharge port 503.

### CITATION LIST

### Patent Literature

Patent document 1: Japanese laid-open patent publication No. S64-36998

### SUMMARY OF INVENTION

### Technical Problem

However, the liquefied gas in the suction container 505 vaporizes with a slight change in the heat input into the suction container 505, and as a result, bubbles are likely to be generated on a liquid surface of the liquefied gas. The liquid surface of the liquefied gas undulates due to the generated bubbles, and the liquid surface fluctuates greatly up and down. Such undulation of the liquid surface can cause a change in an amount of heat transferred from a room-temperature region outside the suction container 505 through the wall surface of the suction container 505 to the liquefied gas. The liquefied gas in the suction container 505 further vaporizes, and bubbles are likely to be generated. As a result, the boil-off gas in the suction container 505 increases. In addition, the undulation of the liquid surface can cause convection in a gas layer, which causes the liquefied gas to further vaporize, and bubbles are likely to be generated.

When the boil-off gas in the suction container 505 increases, a loss of the liquefied gas increases. Furthermore, when the bubbles enter the pump 500, a pump head is lowered, and a loss of discharge rate of the pump 500 will occur. Consequently, the operation of the pump 500 becomes unstable.

In particular, liquid hydrogen vaporizes very easily because its boiling point under the atmospheric pressure is −253° C. For this reason, it is required to improve thermal insulation of the suction container 505, reduce the amount of heat input into the suction container 505, stabilize the liquid surface of the liquefied gas, and reduce the amount of boil-off gas in the suction container 505 as much as possible.

The same problem can occur not only in the pump apparatus for liquefied gas, but also in turbine power generator for liquefied gas. Natural gas or hydrogen is repeatedly compressed, cooled, and expanded in a liquefaction plant to become liquefied gas. Since the liquefied gas is in a liquid state, it is suitable for its transportation. The turbine power generator is used in the expansion process of this liquefaction cycle. The expansion process can improve the efficiency of the liquefaction plant due to an increase in the amount of liquefaction and recovery of electrical energy. The turbine power generator has a turbine machine arranged in a suction container. In this turbine power generator, as in the pump apparatus shown in FIG. 17, it is required to reduce the amount of boil-off gas in the suction container as much as possible.

Therefore, the present invention provides a pump apparatus having an improved thermal insulation of a suction container in which a pump for delivering liquefied gas is disposed, and a turbine power generator having an improved thermal insulation of a suction container in which a turbine, rotated by a fluid energy of liquefied gas, is disposed.

### Solution to Problem

In an embodiment, there is provided a pump apparatus for delivering liquefied gas, comprising: a suction container; and a pump disposed in the suction container, wherein the suction container includes: a vacuum insulation container having a double-wall structure in which a vacuum is formed; and a vacuum insulation lid having a hermetic structure in which a vacuum is formed, the pump is disposed in a pump chamber formed by the vacuum insulation container and the vacuum insulation lid, a gas-layer space for forming a gas insulation layer made of a boil-off gas is formed between an inner surface of the vacuum insulation container and an outer surface of the hermetic structure, and the gas-layer space communicates with the pump chamber.

In an embodiment, the pump apparatus further comprises a baffle structure disposed in the suction container and located above the pump.

In an embodiment, the baffle structure is disposed between the vacuum insulation lid and the pump.

In an embodiment, the baffle structure comprises a baffle plate disposed between the pump and the hermetic structure.

In an embodiment, the pump apparatus further comprises a discharge pipe coupled to a discharge outlet of the pump, the discharge pipe extending through the vacuum insulation lid, the baffle plate being fixed to the discharge pipe.

In an embodiment, the baffle plate is fixed to an inner surface of the vacuum insulation container.

In an embodiment, the baffle plate is located above a liquid surface of the liquefied gas in the vacuum insulation container.

In an embodiment, the baffle plate is located below a liquid surface of the liquefied gas in the vacuum insulation container.

In an embodiment, the baffle structure is fixed to the hermetic structure.

In an embodiment, the baffle structure comprises a labyrinth flow-path structure that defines a labyrinth flow path.

The suction container comprises the vacuum insulation container having the double-wall structure with the vacuum formed therein. This configuration can significantly reduce the amount of heat input from the side of the suction container.

During pump operation, a part of the liquefied gas in the suction container vaporizes to form boil-off gas. This boil-off gas accumulates in the gas-layer space formed in a dead-end space structure at the top of the suction container, and functions as the gas insulation layer. This gas insulation layer is one of insulation structures that are applied to parts that cannot be provided with the vacuum insulation layer. The gas insulation layer can improve the thermal insulation against heat input from above the suction container through the inner wall of the vacuum insulation container.

Furthermore, the baffle structure arranged below the gas-layer space can reduce an influence of undulation of the liquid surface of the liquefied gas in the vacuum insulation container that occurs during pump operation, and can prevent fluidization or convection of the gas insulation layer made of the boil-off gas.

In an embodiment, there is provided a pump apparatus for delivering liquefied gas, comprising: a suction container having a suction port; a pump disposed in the suction container; and a boil-off gas discharge pipe coupled to the suction container, wherein the suction container includes: a thermal insulation container; and a vacuum insulation lid having a hermetic structure in which a vacuum is formed, the pump is disposed in a pump chamber formed by the thermal insulation container and the vacuum insulation lid, a gas-layer space for forming a gas insulation layer made of a boil-off gas is formed between an inner surface of the thermal insulation container and an outer surface of the hermetic structure, the gas-layer space communicates with the pump chamber, and the boil-off gas discharge pipe opens in the suction container at a position lower than the gas-layer space.

In an embodiment, the boil-off gas discharge pipe is coupled to a side wall of the thermal insulation container at a position lower than the gas-layer space.

In an embodiment, the boil-off gas discharge pipe includes a first pipe and a second pipe extending upward from the first pipe, the first pipe being coupled to a side wall of the thermal insulation container at a position between the suction port and the gas-layer space.

In an embodiment, the vacuum insulation lid closes an upper opening of the thermal insulation container to form a dead-end space in an upper portion of the thermal insulation container that does not allow gas to escape.

In an embodiment, the boil-off gas discharge pipe extends through the vacuum insulation lid and protrudes downward from a bottom surface of the vacuum insulation lid.

In an embodiment, the thermal insulation container comprises a vacuum insulation container having a double-wall structure in which a vacuum is formed.

In an embodiment, there is provided a turbine power generator for generating electric power by utilizing fluid energy of liquefied gas, comprising: a suction container; and a turbine machine disposed in the suction container, wherein the suction container includes: a vacuum insulation container having a double-wall structure in which a vacuum is formed; and a vacuum insulation lid having a hermetic structure in which a vacuum is formed, the turbine machine is disposed in a turbine chamber formed by the vacuum insulation container and the vacuum insulation lid, a gas-layer space for forming a gas insulation layer made of a boil-off gas is formed between an inner surface of the vacuum insulation container and an outer surface of the hermetic structure, and the gas-layer space communicates with the turbine chamber.

In an embodiment, there is provided a turbine power generator for generating electric power by utilizing fluid energy of liquefied gas, comprising: a suction container having a suction port; a turbine machine disposed in the suction container; and a boil-off gas discharge pipe coupled to the suction container, wherein the suction container includes: a thermal insulation container; and a vacuum insulation lid having a hermetic structure in which a vacuum is formed, the turbine machine is disposed in a turbine chamber formed by the thermal insulation container and the vacuum insulation lid, a gas-layer space for forming a gas insulation layer made of a boil-off gas is formed between an inner surface of the thermal insulation container and an outer surface of the hermetic structure, the gas-layer space communicates with the turbine chamber, and the boil-off gas discharge pipe opens in the suction container at a position lower than the gas-layer space.

### Advantageous Effects of Invention

During operation of the pump or the turbine machine, a part of the liquefied gas in the suction container vaporizes to form boil-off gas. This boil-off gas accumulates in the gas-layer space and functions as the gas insulation layer. Therefore, the thermal insulation of the suction container can be improved. Furthermore, the baffle structure arranged below the gas-layer space can reduce the influence of undulation of the liquid surface of the liquefied gas in the vacuum insulation container that occurs during operation of the pump or the turbine machine, and can prevent fluidization or convection of the gas insulation layer made of the boil-off gas. As a result, the baffle structure can maintain the thermal insulation effect provided by the gas insulation layer made of the boil-off gas.

When the liquid surface of the liquefied gas rises during the operation of the pump or the turbine machine, the boil-off gas discharge pipe allows a part of the liquefied gas to escape from the suction container, and prevents the liquid surface of the liquefied gas from approaching the gas insulation layer made of the boil-off gas. As a result, the boil-off gas discharge pipe can prevent fluidization or convection of the gas insulation layer, suppress generation of bubbles, and maintain the insulating effect of the gas insulation layer made of the boil-off gas. Furthermore, the dead-end space formed in the suction container has a closed structure, so that the liquid surface of the liquefied gas is less likely to rise.

In the suction container, the amount of heat transferred from a room-temperature region above the suction container into the suction container can be determined by a distance from the room-temperature region above the suction container to the opening position of the boil-off gas discharge pipe, so that the increase in the amount of heat input into the suction container can be suppressed, and the fluctuation of the liquid surface of the liquefied gas can be stabilized. As a result, the amount of boil-off gas in the suction container can be reduced.

### BRIEF DESCRIPTION OF DRAWINGS

FIG. 1 is a schematic diagram showing an embodiment of a liquefied-gas delivering system for delivering liquefied gas;

FIG. 2 is a schematic diagram showing an embodiment of a pump apparatus;

FIG. 3 is an enlarged cross-sectional view showing a part of the pump apparatus shown in FIG. 2;

FIG. 4 is an enlarged cross-sectional view showing another embodiment of the pump apparatus;

FIG. 5 is an enlarged cross-sectional view showing another embodiment of the pump apparatus;

FIG. 6 is an enlarged cross-sectional view showing another embodiment of the pump apparatus;

FIG. 7 is an enlarged cross-sectional view showing another embodiment of the pump apparatus;

FIG. 8 is an enlarged cross-sectional view showing another embodiment of the pump apparatus;

FIG. 9 is an enlarged cross-sectional view showing another embodiment of the pump apparatus;

FIG. 10 is an enlarged cross-sectional view showing a modified example of the embodiment shown in FIG. 9;

FIG. 11 is an enlarged cross-sectional view showing another embodiment of the pump apparatus;

FIG. 12 is an enlarged cross-sectional view showing another embodiment of the pump apparatus;

FIG. 13 is an enlarged cross-sectional view showing another embodiment of the pump apparatus;

FIG. 14 is an enlarged cross-sectional view showing another embodiment of the pump apparatus;

FIG. 15 is an enlarged cross-sectional view showing another embodiment of the pump apparatus;

FIG. 16 is a schematic diagram showing an embodiment of a turbine power generator; and

FIG. 17 is a schematic diagram showing a conventional example of a pump apparatus for delivering liquefied gas.

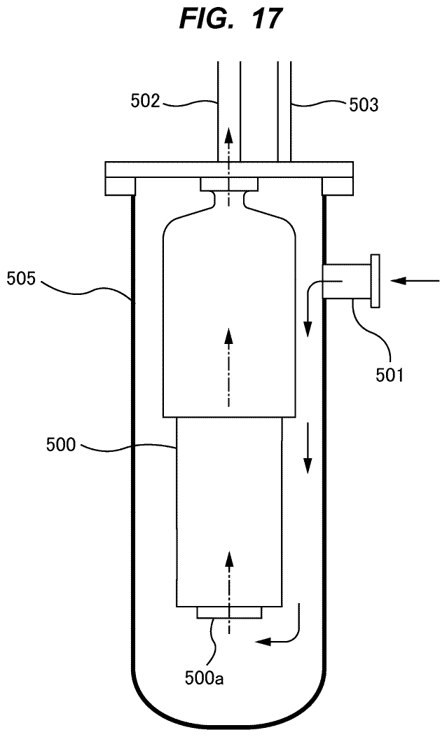

### DESCRIPTION OF EMBODIMENTS

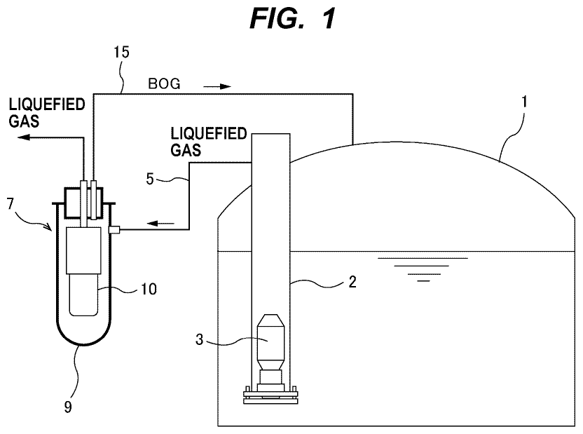

Hereinafter, embodiments of the present invention will be described with reference to the drawings. FIG. 1 is a schematic diagram showing an embodiment of a liquefied-gas delivering system for delivering liquefied gas. As shown in FIG. 1, the liquefied-gas delivering system includes a storage tank 1 for storing the liquefied gas, a pump column 2 arranged in the storage tank 1, an in-tank pump 3 arranged in the pump column 2, and a pump apparatus 7 coupled to the in-tank pump 3 through a liquefied-gas transfer line 5. Examples of the liquefied gas include liquid hydrogen, liquefied natural gas, liquefied ammonia, liquid nitrogen, liquefied ethylene gas, and liquefied petroleum gas.

The pump apparatus 7 includes a suction container 9, which is a fluid container, and a pump 10 disposed in the suction container 9. The liquefied gas transferred through the liquefied-gas transfer line 5 is introduced into the suction container 9. The pump 10 is configured to deliver the liquefied gas from the suction container 9 to a point of use (not shown) through a discharge pipe 33. A plurality of pump apparatuses 7 may be coupled in series to pressurize the liquefied gas up to a target pressure.

A small amount of heat from an ambient atmosphere of the pump apparatus 7 is transferred to the liquefied gas in the suction container 9. As a result, a part of the liquefied gas is gasified to form boil-off gas (BOG) in the suction container 9. Therefore, the liquefied-gas delivering system includes a boil-off gas return line 15 for returning the boil-off gas from the suction container 9 to the storage tank 1.

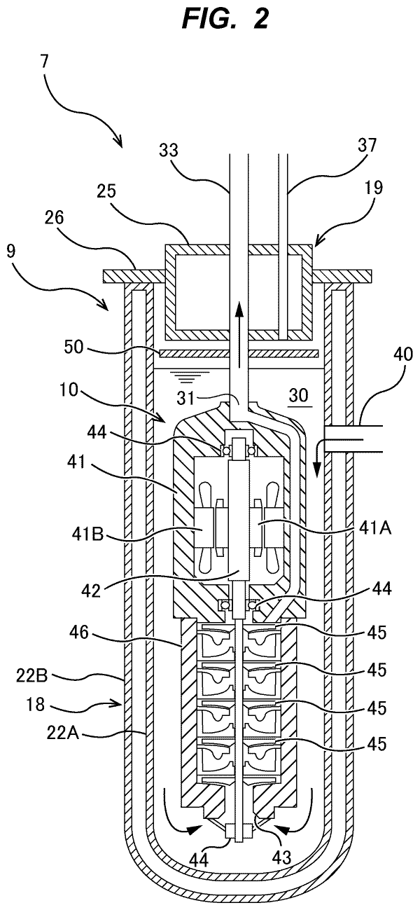

FIG. 2 is a schematic diagram showing an embodiment of the pump apparatus 7. The pump apparatus 7 includes the suction container 9 and the pump 10 disposed in the suction container 9. The suction container 9 includes a vacuum insulation container 18 having a double-wall structure with a vacuum formed therein, and a vacuum insulation lid 19 that closes an upper opening of the vacuum insulation container 18. A side wall and a bottom wall of the vacuum insulation container 18 are configured with a double-wall structure including an inner wall 22A and an outer wall 22B. The vacuum is formed between the inner wall 22A and the outer wall 22B. The vacuum insulation container 18 of this embodiment has a circular horizontal cross section, while in one embodiment, the vacuum insulation container 18 may have a horizontal cross section of another shape, such as a polygonal shape.

The vacuum insulation lid 19 has a hermetic structure 25 in which a vacuum is formed, and a flange 26 fixed to an outer surface of the hermetic structure 25. The flange 26 is detachably fixed to an upper end of the vacuum insulation container 18 by fastening device (not shown), such as screw. The suction container 9 is composed of the vacuum insulation container 18 having the double-wall structure in which the vacuum is formed, and the vacuum insulation lid 19 having the hermetic structure 25 in which the vacuum is formed, so that an amount of heat input from side and bottom of the suction container 9 can be significantly reduced. Although a small amount of heat may input through the inner wall 22A of the vacuum insulation container 18, the heat input from the top of the suction container 9 is mostly reduced by the hermetic structure 25 in which the vacuum is formed inside the vacuum insulation lid 19.

A lower part of the hermetic structure 25 is located inside the vacuum insulation container 18, and an upper part of the hermetic structure 25 and the flange 26 are located outside the vacuum insulation container 18. The pump 10 is disposed in a pump chamber 30 formed by the vacuum insulation container 18 and the vacuum insulation lid 19.

The pump apparatus 7 further includes discharge pipe 33 coupled to a discharge port 31 of the pump 10 and extending to the outside of the pump chamber 30 through the vacuum insulation lid 19. The pump apparatus 7 further includes a boil-off gas discharge pipe 37 extending through the vacuum insulation lid 19 and providing fluid communication between the inside and the outside of the pump chamber 30. The discharge pipe 33 is fixed to the hermetic structure 25 and the pump 10, and the boil-off gas discharge pipe 37 is fixed to the hermetic structure 25.

The suction container 9 has a suction port 40 coupled to the side wall of the vacuum insulation container 18. The liquefied gas transferred through the liquefied-gas transfer line 5 shown in FIG. 1 is introduced into the suction container 9 through the suction port 40. During operation of the pump 10, the entire pump 10 is immersed in the liquefied gas. Therefore, the pump 10 is a submersible pump that can operate in the liquefied gas.

The pump 10 includes an electric motor 41 having a motor rotor 41A and a motor stator 41B, a rotational shaft 42 coupled to the electric motor 41, a plurality of bearings 44 that rotatably support the rotational shaft 42, a plurality of impellers 45 fixed to the rotational shaft 42, and a pump casing 46 in which the plurality of impellers 45 are arranged. In one embodiment, the pump 10 may include a single impeller 45.

When electric power is supplied to the electric motor 41 through a power cable (not shown), the electric motor 41 rotates the rotational shaft 42 and the impellers 45 together. As the impellers 45 rotate, the liquefied gas is sucked into the pump 10 through a suction inlet 43 of the pump 10 and discharged into the discharge pipe 33 through a discharge outlet 31. The liquefied gas then flows through the discharge pipe 33 and is delivered to a point of use.

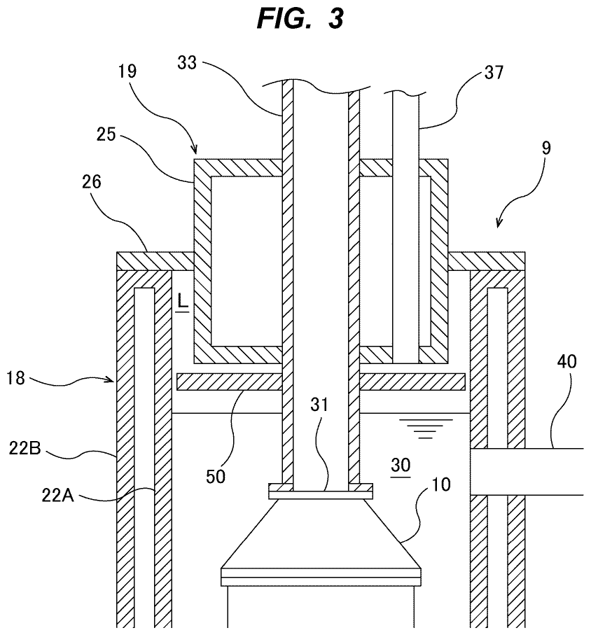

FIG. 3 is an enlarged cross-sectional view showing a part of the pump apparatus shown in FIG. 2. As shown in FIG. 3, a gas-layer space L is formed between an inner surface of the vacuum insulation container 18 and the outer surface of the hermetic structure 25. More specifically, the gas-layer space L is surrounded by an inner surface of the inner wall 22A of the vacuum insulation container 18, a side surface of the hermetic structure 25, and a lower surface of the flange 26. A gas insulation layer made of the boil-off gas is formed in this gas-layer space L. The gas-layer space L communicates with the pump chamber 30 in the vacuum insulation container 18. A part of the boil-off gas generated in the pump chamber 30 is introduced to the gas-layer space L.

During operation of the pump 10, a small amount of heat input from the outside of the suction container 9 and/or heat generated by the electric motor 41 of the pump 10 causes a part of the liquefied gas to evaporate to form the boil-off gas. The gas-layer space L is surrounded by the inner surface of the inner wall 22A of the vacuum insulation container 18, the side of the hermetic structure 25, and the lower surface of the flange 26, forming a dead-end space structure that does not allow the gas to escape to the outside, so that the boil-off gas accumulates in the gas-layer space L to form the gas insulation layer. This gas insulation layer in the gas-layer space L is located between the vacuum insulation container 18 and the vacuum insulation lid 19, and can therefore prevent heat input from outside at a position between the vacuum insulation container 18 and the vacuum insulation lid 19, particularly heat input from the flange 26 of the vacuum insulation lid 19 at the top of the suction container 9 through the inner wall 22A of the vacuum insulation container 18. Therefore, the gas insulation layer made of the boil-off gas can improve the thermal insulation of the suction container 9. The excess boil-off gas is discharged from the suction container 9 through the boil-off gas discharge pipe 37 communicating with the pump chamber 30, and is returned to the storage tank 1 through the boil-off gas return line 15 shown in FIG. 1.

As shown in FIG. 3, the pump apparatus 7 further includes a baffle structure 50. The baffle structure 50 is disposed in the suction container 9 (more specifically, in the vacuum insulation container 18) and disposed above the pump 10. The baffle structure 50 is located below the gas-layer space L. The baffle structure 50 of this embodiment is a baffle plate disposed between the pump 10 and the hermetic structure 25. Specifically, the baffle structure 50 is located above the pump 10 and below the hermetic structure 25. The baffle structure (baffle plate) 50 is fixed to the discharge pipe 33. The baffle structure 50 of this embodiment has a disk shape.

The baffle structure (baffle plate) 50 is located above the liquid surface of the liquefied gas in the vacuum insulation container 18. An outer edge of the baffle structure 50 is separated from the inner surface of the vacuum insulation container 18 (i.e., does not contact the inner surface of the vacuum insulation container 18). Therefore, the boil-off gas generated in the pump chamber 30 moves to the gas-layer space L through a gap between the baffle structure 50 and the inner surface of the vacuum insulation container 18, and forms the gas insulation layer in the gas-layer space L. As long as the fluid communication between the gas-layer space L and the pump chamber 30 is established, in one embodiment, a part of the outer edge of the baffle structure 50 may contact the inner surface of the vacuum insulation container 18.

During the operation of the pump 10, the liquefied gas in the suction container 9 flows at a fairly high speed. Therefore, the liquid surface of the liquefied gas in the suction container 9 may undulate (wave). In particular, when a large amount of liquefied gas is to be delivered, the liquefied gas may splash in the suction container 9. The baffle structure 50 arranged below the gas-layer space L can prevent such disturbance of the liquid surface of the liquefied gas from causing a fluid flow in the space filled with boil-off gas above the liquid surface of the liquefied gas, and can thus suppress an influence on the gas insulation layer made of the boil-off gas in the gas-layer space L, and can prevent fluidization or convection of the gas insulation layer. It is desirable that the gas insulation layer made of the boil-off gas in the gas-layer space L be as still as possible. The reason is to prevent the heat outside the suction container 9 from being transferred to the liquefied gas by the convection of the boil-off gas in the gas-layer space L.

The baffle structure 50 can suppress fluidization or convection of the gas insulation layer caused by disturbances of the liquid surface of the liquefied gas that may occur when the pump 10 is in operation. As a result, the thermal insulation of the gas insulation layer made of the boil-off gas can be maintained.

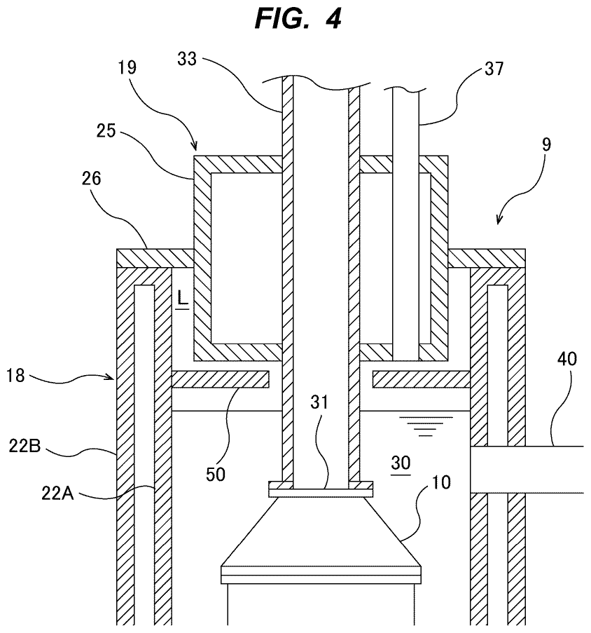

FIG. 4 is an enlarged cross-sectional view showing another embodiment of the pump apparatus 7. Configuration and operation of this embodiment that will not be particularly described are the same as those of the embodiments described with reference to FIGS. 1 to 3, and therefore duplicated description will be omitted.

In the embodiment shown in FIG. 4, the baffle structure 50 is a baffle plate fixed to the inner surface of the vacuum insulation container 18. In this embodiment, the vacuum insulation container 18 has a circular horizontal cross section, and the baffle structure (baffle plate) 50 is annular. The baffle structure (baffle plate) 50 is disposed between the vacuum insulation lid 19 and the pump 10.

An inner edge of the baffle structure 50 is separated from an outer surface of the discharge pipe 33 (i.e., not in contact with the discharge pipe 33). Therefore, the gas-layer space L is in fluid communication with the pump chamber 30. In this embodiment, the baffle structure 50 can also protect the gas insulation layer from the turbulent flow of the liquefied gas that may occur during operation of the pump 10. As a result, the thermal insulation of the gas insulation layer made of the boil-off gas can be maintained. As long as the fluid communication between the gas-layer space L and the pump chamber 30 is established, in one embodiment, a part of the inner edge of the baffle structure 50 may be in contact with the outer surface of the discharge pipe 33.

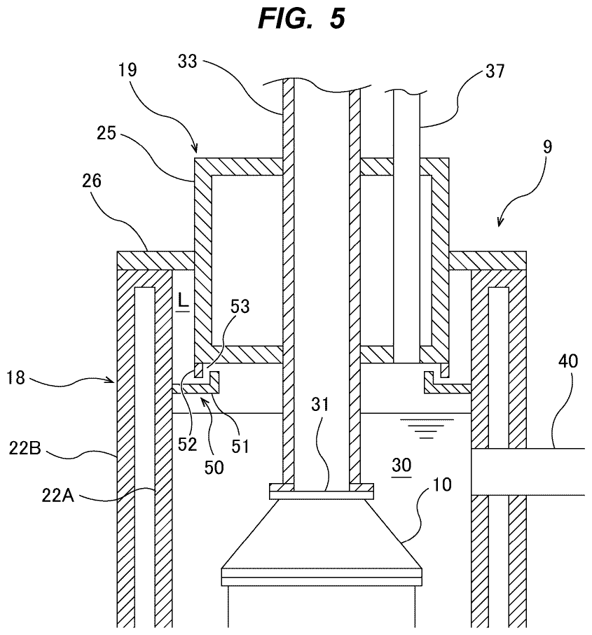

FIG. 5 is an enlarged cross-sectional view showing another embodiment of the pump apparatus 7. Configuration and operation of this embodiment that will not be particularly described are the same as those of the embodiments described with reference to FIGS. 1 to 3, and therefore duplicated description will be omitted.

In the embodiment shown in FIG. 5, the baffle structure 50 comprises a labyrinth flow-path structure that forms a labyrinth flow path 53. In this example, the baffle structure 50 has a first flow-path structure 51 fixed to the inner surface of the vacuum insulation container 18 and a second flow-path structure 52 fixed to the hermetic structure 25. The labyrinth flow path 53 is formed between the first flow-path structure 51 and the second flow-path structure 52. The gas-layer space L and the pump chamber 30 are in fluid communication through the labyrinth flow path 53. The baffle structure (labyrinth flow-path structure) 50 is disposed between the vacuum insulation lid 19 and the pump 10. The baffle structure 50 that constitutes the labyrinth flow-path structure can protect the gas insulation layer from the turbulent flow of the liquefied gas that may occur during the operation of the pump 10. As a result, the thermal insulation of the gas insulation layer made of the boil-off gas can be maintained.

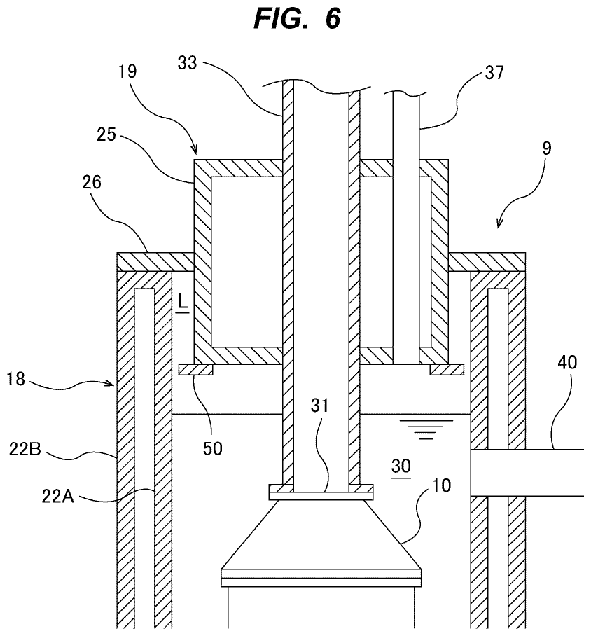

FIG. 6 is an enlarged cross-sectional view showing another embodiment of the pump apparatus 7. Configuration and operation of this embodiment that will not be particularly described are the same as those of the embodiments described with reference to FIGS. 1 to 3, and therefore duplicated description will be omitted.

In the embodiment shown in FIG. 6, the baffle structure 50 is fixed to the hermetic structure 25. The baffle structure 50 protrudes from the hermetic structure 25 toward the inner surface of the vacuum insulation container 18. An outer edge of the baffle structure 50 is separated from the inner surface of the vacuum insulation container 18 (i.e., does not contact the inner surface of the vacuum insulation container 18). Therefore, the boil-off gas generated in the pump chamber 30 moves to the gas-layer space L through a gap between the baffle structure 50 and the inner surface of the vacuum insulation container 18 to form the gas insulation layer in the gas-layer space L. As long as the fluid communication between the gas-layer space L and the pump chamber 30 is established, in one embodiment, a part of the outer edge of the baffle structure 50 may contact the inner surface of the vacuum insulation container 18.

In the embodiment shown in FIG. 6, the baffle structure 50 is an annular member secured to the bottom surface of the hermetic structure 25. In one embodiment, the baffle structure 50 may be an annular member secured to the side surface of the hermetic structure 25.

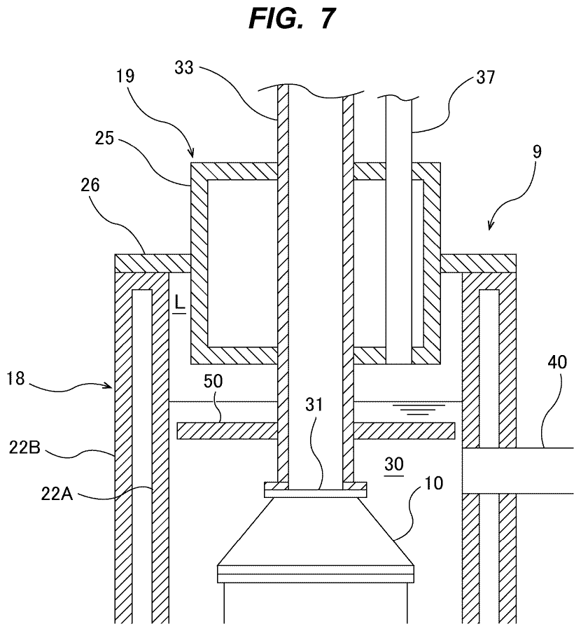

FIG. 7 is an enlarged cross-sectional view showing another embodiment of the pump apparatus 7. Configuration and operation of this embodiment that will not be particularly described are the same as those of the embodiments described with reference to FIGS. 1 to 3, and therefore duplicated description will be omitted.

In the embodiment shown in FIG. 7, the baffle structure 50 is a baffle plate located below the liquid surface of the liquefied gas in the vacuum insulation container 18. Specifically, the baffle structure (baffle plate) 50 is fixed to the discharge pipe 33 and located in the liquefied gas in the vacuum insulation container 18. This baffle structure (baffle plate) 50 can calm the liquid surface of the liquefied gas in the vacuum insulation container 18. As a result, the thermal insulation of the gas insulation layer made of the boil-off gas can be maintained.

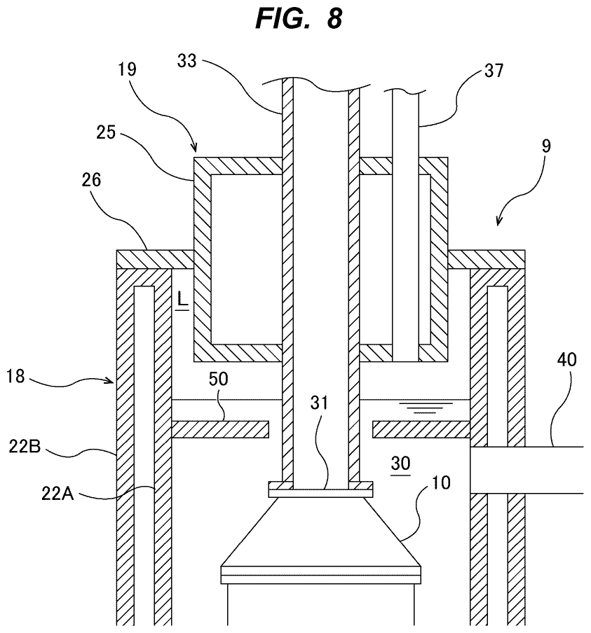

FIG. 8 is an enlarged cross-sectional view showing another embodiment of the pump apparatus 7. Configuration and operation of this embodiment that will not be particularly described are the same as those of the embodiment described with reference to FIG. 4, and therefore duplicated description will be omitted.

In the embodiment shown in FIG. 8, the baffle structure 50 is a baffle plate located below the liquid surface of the liquefied gas in the vacuum insulation container 18. Specifically, the baffle structure (baffle plate) 50 is fixed to the inner surface of the vacuum insulation container 18 and disposed in the liquefied gas in the vacuum insulation container 18. This baffle structure (baffle plate) 50 can calm the liquid surface of the liquefied gas in the vacuum insulation container 18. As a result, the thermal insulation of the gas insulation layer made of the boil-off gas can be maintained.

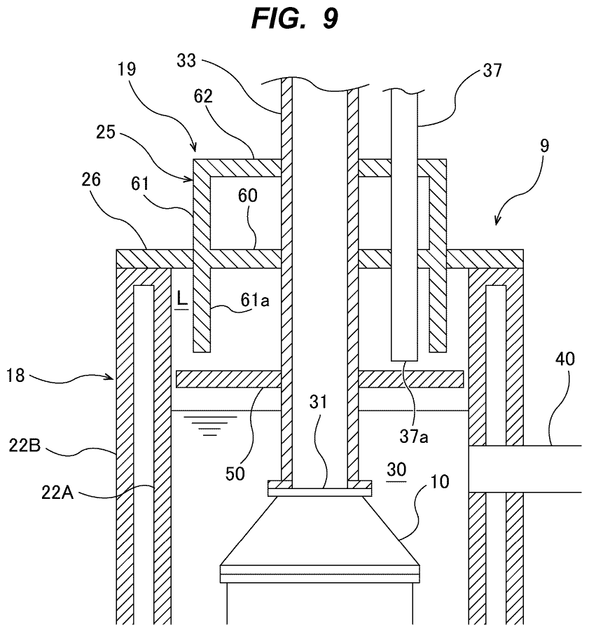

FIG. 9 is an enlarged cross-sectional view showing another embodiment of the pump apparatus 7. Configuration and operation of this embodiment that will not be particularly described are the same as those of the embodiment described with reference to FIG. 3, and therefore duplicated description will be omitted.

In the embodiment shown in FIG. 9, the vacuum is formed inside the hermetic structure 25 by a side wall 61, an upper wall 62, and a raised bottom wall 60 of the hermetic structure 25. The raised bottom wall 60 is located higher than a lower end of the side wall 61. More specifically, the raised bottom wall 60 is located at the same height as the flange 26. The side wall 61 has a portion 61a extending downward from the raised bottom wall 60. The gas-layer space L is formed between an outer surface of the downwardly extending portion 61a and the inner surface of the inner wall 22A of the vacuum insulation container 18. The boil-off gas discharge pipe 37 communicating with the pump chamber 30 extends through the vacuum insulation lid 19. The boil-off gas discharge pipe 37 has a boil-off gas inlet 37a located lower than the gas-layer space L and higher than the suction port 40.

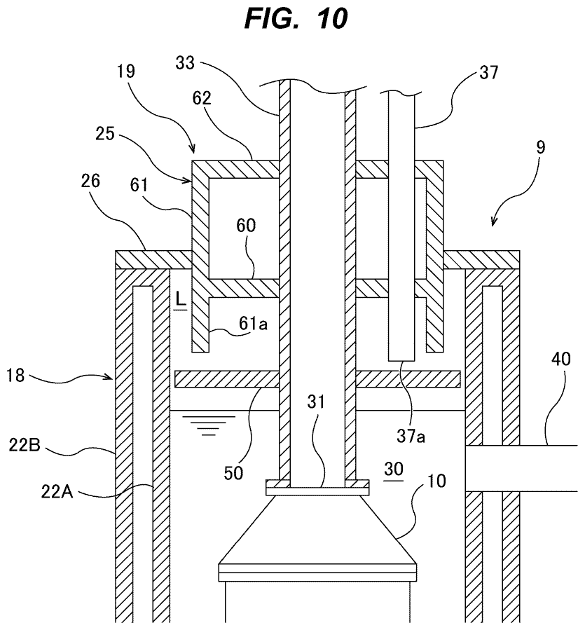

FIG. 10 shows a modified example of the embodiment shown in FIG. 9. In this modified example, the raised bottom wall 60 of the hermetic structure 25 is located lower than the flange 26 and higher than the lower end of the side wall 61. The other configurations are the same as those of the embodiment shown in FIG. 9. The hermetic structure 25 of the embodiments shown in FIGS. 9 and 10 can be applied to the embodiments described with reference to FIGS. 4 to 7.

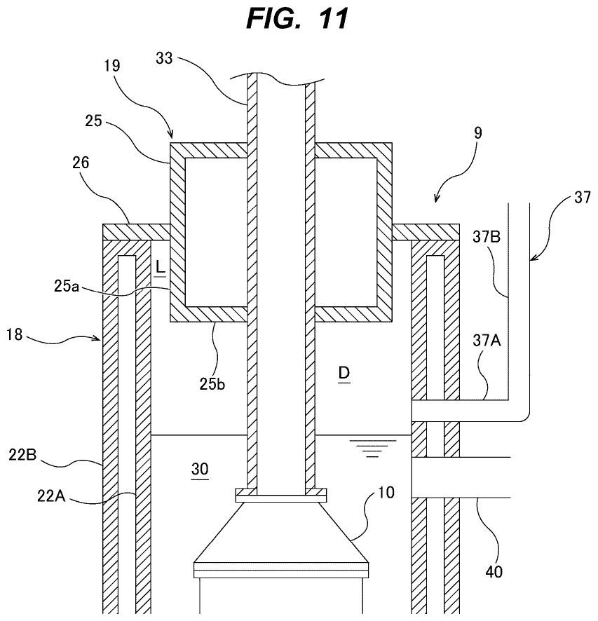

FIG. 11 is an enlarged cross-sectional view showing another embodiment of the pump apparatus 7. Configuration and operation of this embodiment that will not be particularly described are the same as those of the embodiments described with reference to FIGS. 1 to 3, and therefore duplicated description will be omitted.

In this embodiment, the baffle structure 50 of each of the above-mentioned embodiments is not provided. Instead, the boil-off gas discharge pipe 37 is coupled to the side wall of the vacuum insulation container 18 and extends through the side wall of the vacuum insulation container 18. The suction port 40 is coupled to the side wall of the vacuum insulation container 18 at a position lower than the boil-off gas discharge pipe 37. The coupling position between the boil-off gas discharge pipe 37 and the side wall of the vacuum insulation container 18 is lower than the gas-layer space L. The baffle structure 50 of each of the above-mentioned embodiments may be disposed in liquid or gas. The combination of the boil-off gas discharge pipe 37 of this embodiment and the baffle structure 50 can also achieve the object of this embodiment.

The boil-off gas discharge pipe 37 is not provided in the vacuum insulation lid 19. The vacuum insulation lid 19 seals the upper opening of the vacuum insulation container 18, thus forming a dead-end space D in the upper part of the vacuum insulation container 18 that does not allow the gas to escape. The dead-end space D is surrounded by the inner surface of the inner wall 22A of the vacuum insulation container 18, the side surface 25a and the bottom surface 25b of the hermetic structure 25, and the lower surface of the flange 26. Therefore, the gas-layer space L constitutes a part of the dead-end space D.

The boil-off gas discharge pipe 37 opens in the suction container 9 at a position lower than the gas-layer space L. The boil-off gas discharge pipe 37 has a first pipe 37A coupled to the side wall of the vacuum insulation container 18 and a second pipe 37B extending upward from the first pipe 37A. The first pipe 37A extends in a lateral direction, and the second pipe 37B extends in a vertical direction. The coupling position of the first pipe 37A and the side wall of the vacuum insulation container 18 is located between the suction port 40 and the gas-layer space L. The boil-off gas discharge pipe 37 is coupled to the boil-off gas return line 15 shown in FIG. 1.

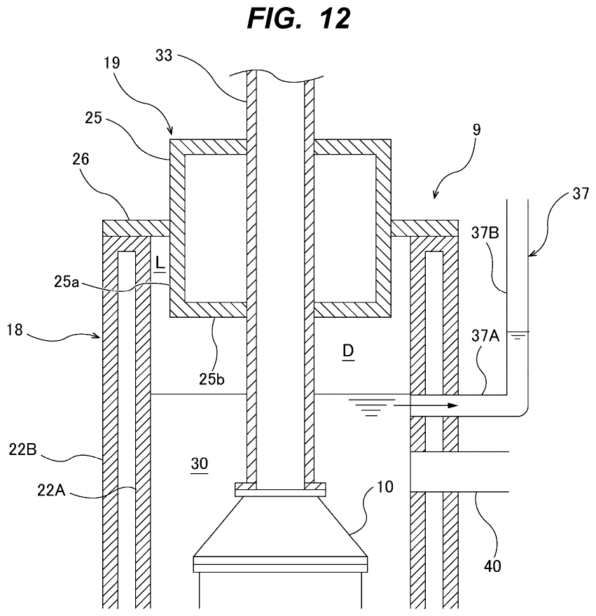

In FIG. 11, the liquid surface of the liquefied gas in the vacuum insulation container 18 is lower than the coupling position between the boil-off gas discharge pipe 37 and the side wall of the vacuum insulation container 18. During the operation of the pump 10, the liquid surface of the liquefied gas may rise suddenly. As shown in FIG. 12, when the liquid surface of the liquefied gas rises, the boil-off gas discharge pipe 37 allows a part of the liquefied gas to escape from the vacuum insulation container 18. On the other hand, the dead-end space D is located higher than the position at which the boil-off gas discharge pipe 37 is coupled to the suction container 9, and this dead-end space D is closed by the vacuum insulation lid 19 and the vacuum insulation container 18. Therefore, the pressure of the dead-end space D increases as the liquid surface of the liquefied gas rises. This increased pressure of the dead-end space D can prevent the liquid surface of the liquefied gas from rising. Therefore, the liquid surface of the liquefied gas does not rise above the coupling position of the boil-off gas discharge pipe 37 in the suction container 9. This makes it possible to prevent the liquid surface of the liquefied gas from approaching the gas insulation layer made of the boil-off gas present in the gas-layer space L. As a result, the configuration of this embodiment can prevent fluidization or convection of the gas insulation layer in the gas-layer space L, and can maintain the thermal insulation of the gas insulation layer made of the boil-off gas.

In addition, the amount of heat input to the liquid surface due to thermal conduction from the room-temperature region above the inner wall 22A of the suction container 9 to the liquid surface can be made constant. This is because the liquid surface does not rise from the position of the first pipe 37A and the thickness of the gas insulation layer in the dead-end space D does not change, so that a heat transfer distance from the room-temperature region above the inner wall 22A to the liquid surface can be made constant. Therefore, the amount of heat transfer is constant, and an increase in the amount of heat transfer can be suppressed.

As shown in FIG. 12, the liquefied gas rises to a certain level in the second pipe 37B extending vertically, but does not flow any higher. The dead-end space D formed in the vacuum insulation container 18 can make it difficult for the liquid surface of the liquefied gas to rise in the vacuum insulation container 18.

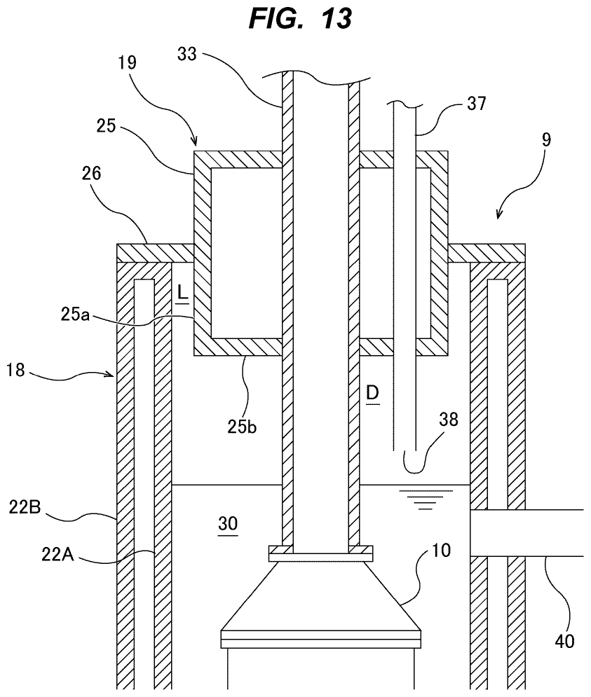

FIG. 13 is an enlarged cross-sectional view showing another embodiment of the pump apparatus 7. Configuration and operation of this embodiment that will not be particularly described are the same as those of the embodiment described with reference to FIG. 11, and therefore duplicated description will be omitted.

The boil-off gas discharge pipe 37 extends through the vacuum insulation lid 19 and protrudes downward from the bottom surface 25b of the vacuum insulation lid 19. More specifically, the boil-off gas discharge pipe 37 vertically penetrates the hermetic structure 25 in which the vacuum is formed. The boil-off gas discharge pipe 37 has a lower-end opening 38 located below the gas-layer space L. Therefore, the boil-off gas discharge pipe 37 opens in the suction container 9 at a position below the gas-layer space L.

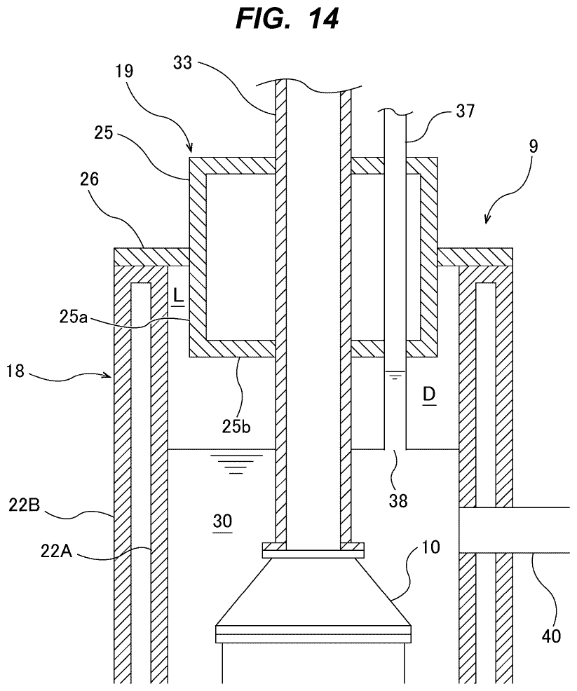

As shown in FIG. 14, when the liquid surface of the liquefied gas rises, the boil-off gas discharge pipe 37 allows a part of the liquefied gas to escape from the suction container 9. On the other hand, the dead-end space D is located higher than the lower-end opening 38 of the boil-off gas discharge pipe 37, and this dead-end space D is closed by the vacuum insulation lid 19 and the vacuum insulation container 18. This increased pressure of the dead-end space D can prevent the liquid surface of the liquefied gas from rising. Therefore, the liquid surface of the liquefied gas does not rise above the lower-end opening 38 of the boil-off gas discharge pipe 37 in the suction container 9. The dead-end space D formed in the suction container 9 can make it difficult for the liquid surface of the liquefied gas to rise in the suction container 9.

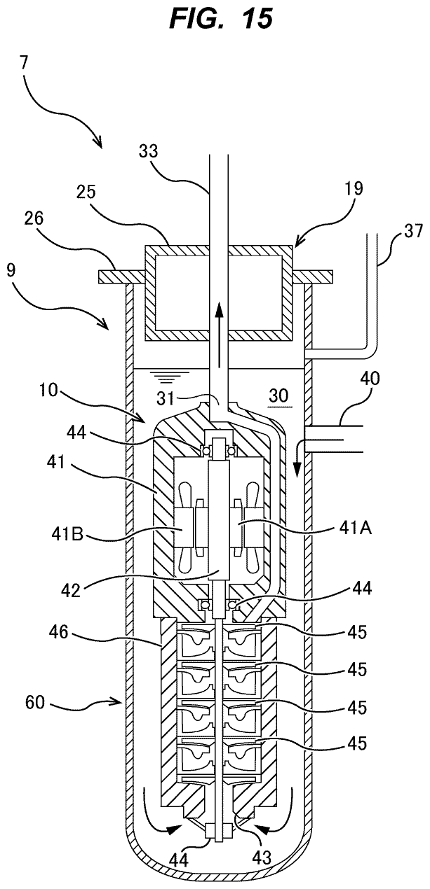

The vacuum insulation container 18 shown in FIGS. 11 to 14 is one embodiment of a thermal insulation container having a double-wall structure in which a vacuum is formed inside, but the thermal insulation container is not limited to the vacuum insulation container 18. In one embodiment, as shown in FIG. 15, the suction container 9 may comprise a thermal insulation container 60 having a single-wall structure, instead of the vacuum insulation container 18 having the double-wall structure. The flange 26 of the vacuum insulation lid 19 is detachably fixed to an upper end of the thermal insulation container 60 by fastening device, such as screw (not shown). The suction port 40 is coupled to a side wall of the thermal insulation container 60. Although not shown in the drawings, the embodiment of the thermal insulation container 60 having a single-wall structure shown in FIG. 15 can be applied to the embodiment described with reference to FIGS. 13 and 14. Other detailed configurations of the suction container 9 are the same as those of the embodiments described with reference to FIGS. 1 to 14, so that overlapping descriptions will be omitted.

The embodiments described with reference to FIGS. 1 to 15 are directed to the pump apparatus that pressurizes the liquefied gas. However, the embodiments described with reference to FIGS. 1 to 15 are not limited to the pump apparatus and can be applied to a turbine power generator that generates electric power by utilizing fluid energy of the liquefied gas.

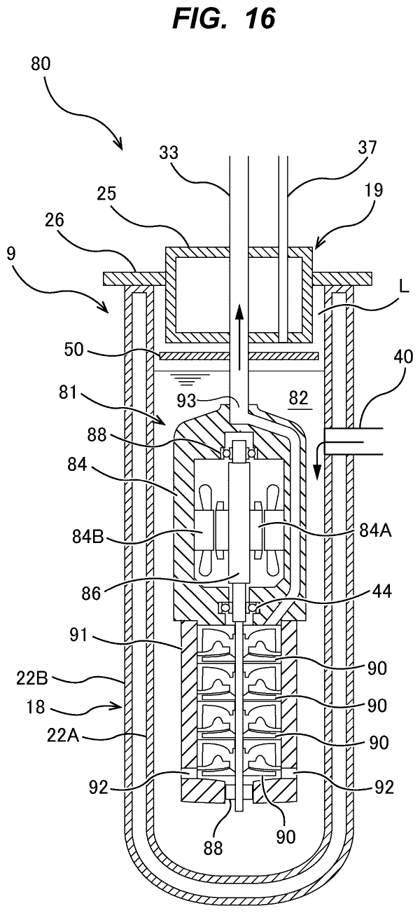

FIG. 16 is a schematic diagram showing one embodiment of a turbine power generator. The same components as those in the embodiments shown in FIG. 2 are denoted by the same reference numerals, and duplicated explanations will be omitted. A turbine power generator 80 includes the suction container 9 and a turbine machine 81 arranged in the suction container 9. The turbine machine 81 is arranged in a turbine chamber 82 formed in the suction container 9. The gas-layer space L communicates with the turbine chamber 82.

The turbine machine 81 has a power generator 84 having a rotor 84A and a stator 84B, a rotational shaft 86 coupled to the power generator 84, a plurality of bearings 88 that rotatably support the rotational shaft 86, a plurality of impellers 90 fixed to the rotational shaft 86, and a turbine casing 91 in which the plurality of impellers 90 are arranged. In one embodiment, the turbine machine 81 may include a single impeller 90.

A high-pressure liquefied gas is introduced into the suction container 9 through the suction port 40. During operation of the turbine machine 81, the entire turbine machine 81 is immersed in the liquefied gas. Therefore, the turbine machine 81 is a submergible turbine machine capable of operating in the liquefied gas. The high-pressure liquefied gas flows into the turbine machine 81 through fluid inlets 92 formed in a side wall of the turbine casing 91, and rotates the plurality of impellers 90. The rotation of the impellers 90 rotates the power generator 84 via the rotational shaft 86, so that the power generator 84 can generate electric power. The pressure of the liquefied gas is reduced when the liquefied gas is passing through the plurality of impellers 90. The low-pressure liquefied gas then flows out through a discharge outlet 93 of the turbine machine 81 into the discharge pipe 33, and flows through the discharge pipe 33.

Although overlapping depictions are omitted, the embodiments described with reference to FIGS. 2 to 14 can be applied to the turbine power generator 80. In this case, the pump 10 in FIGS. 2 to 14 is replaced with the turbine machine 81, the pump chamber 30 is replaced with the turbine chamber 82, and the discharge outlet 31 is replaced with the discharge outlet 93. Furthermore, the embodiment of the thermal insulation container 60 described with reference to FIG. 15 can be applied to the combination of the embodiments shown in FIGS. 11 to 14 and the turbine machine 81.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments. Therefore, the present invention is not intended to be limited to the embodiments described herein but is to be accorded the widest scope as defined by limitation of the claims.

### INDUSTRIAL APPLICABILITY

The present invention is applicable to a pump apparatus for delivering liquefied gas, such as liquid hydrogen, liquid nitrogen, liquefied ammonia, liquefied natural gas, liquefied ethylene gas, or liquefied petroleum gas, and a turbine power generator for use in a liquefaction plant for liquefied gas.

### REFERENCE SIGNS LIST

1 storage tank
2 pump column
3 in-tank pump
5 liquefied-gas transfer line
7 pump apparatus
9 suction container
10 pump
15 boil-off gas return line
18 vacuum insulation container
19 vacuum insulation lid
22A inner wall
22B outer wall
25 hermetic structure
26 flange
30 pump chamber
31 discharge outlet
33 discharge
37 boil-off gas discharge pipe
37A first pipe
37B second pipe
38 lower-end opening
40 suction port
41A motor rotor
41B motor stator
41 electric motor
42 rotational shaft
44 bearing
45 impeller
46 pump casing
50 baffle structure
51 first flow-path structure
52 second flow-path structure
53 labyrinth flow path
60 thermal insulation container
80 turbine power generator
81 turbine machine
82 turbine chamber
84 power generator
86 rotational shaft
88 bearing
90 impeller
91 turbine casing
92 fluid inlet
93 discharge outlet
L gas-layer space
D dead-end space

1. A pump apparatus for delivering liquefied gas, comprising:
a suction container; and
a pump disposed in the suction container,
wherein the suction container includes:
a vacuum insulation container having a double-wall structure in which a vacuum is formed; and
a vacuum insulation lid having a hermetic structure in which a vacuum is formed,
the pump is disposed in a pump chamber formed by the vacuum insulation container and the vacuum insulation lid,
a gas-layer space for forming a gas insulation layer made of a boil-off gas is formed between an inner surface of the vacuum insulation container and an outer surface of the hermetic structure, and

[symbol]

2. The pump apparatus according to claim 1 further comprising a baffle structure disposed in the suction container and located above the pump.

3. The pump apparatus according to claim 2, wherein the baffle structure is disposed between the vacuum insulation lid and the pump.

4. The pump apparatus according to claim 2, wherein the baffle structure comprises a baffle plate disposed between the pump and the hermetic structure.

5. The pump apparatus according to claim 4, further comprising a discharge pipe coupled to a discharge outlet of the pump, the discharge pipe extending through the vacuum insulation lid, the baffle plate being fixed to the discharge pipe.

6. The pump apparatus according to claim 4, wherein the baffle plate is fixed to an inner surface of the vacuum insulation container.

7. The pump apparatus according to claim 4, wherein the baffle plate is located above a liquid surface of the liquefied gas in the vacuum insulation container.

8. The pump apparatus according to claim 4, wherein the baffle plate is located below a liquid surface of the liquefied gas in the vacuum insulation container.

9. The pump apparatus according to claim 2, wherein the baffle structure is fixed to the hermetic structure.

10. The pump apparatus according to claim 2, wherein the baffle structure comprises a labyrinth flow-path structure that defines a labyrinth flow path.

11. A pump apparatus for delivering liquefied gas, comprising:
a suction container having a suction port;
a pump disposed in the suction container; and
a boil-off gas discharge pipe coupled to the suction container,
wherein the suction container includes:
a thermal insulation container; and
a vacuum insulation lid having a hermetic structure in which a vacuum is formed,
the pump is disposed in a pump chamber formed by the thermal insulation container and the vacuum insulation lid,
a gas-layer space for forming a gas insulation layer made of a boil-off gas is formed between an inner surface of the thermal insulation container and an outer surface of the hermetic structure,
the gas-layer space communicates with the pump chamber, and
the boil-off gas discharge pipe opens in the suction container at a position lower than the gas-layer space.

12. The pump apparatus according to claim 11, wherein the boil-off gas discharge pipe is coupled to a side wall of the thermal insulation container at a position lower than the gas-layer space.

13. The pump apparatus according to claim 11, wherein the boil-off gas discharge pipe includes a first pipe and a second pipe extending upward from the first pipe, the first pipe being coupled to a side wall of the thermal insulation container at a position between the suction port and the gas-layer space.

14. The pump apparatus according to claim 11, wherein the vacuum insulation lid closes an upper opening of the thermal insulation container to form a dead-end space in an upper portion of the thermal insulation container that does not allow gas to escape.

15. The pump apparatus according to claim 11, wherein the boil-off gas discharge pipe extends through the vacuum insulation lid and protrudes downward from a bottom surface of the vacuum insulation lid.

16. The pump apparatus according to claim 11, wherein the thermal insulation container comprises a vacuum insulation container having a double-wall structure in which a vacuum is formed.

17. A turbine power generator for generating electric power by utilizing fluid energy of liquefied gas, comprising:
a suction container; and
a turbine machine disposed in the suction container,
wherein the suction container includes:
a vacuum insulation container having a double-wall structure in which a vacuum is formed; and
a vacuum insulation lid having a hermetic structure in which a vacuum is formed,
the turbine machine is disposed in a turbine chamber formed by the vacuum insulation container and the vacuum insulation lid,
a gas-layer space for forming a gas insulation layer made of a boil-off gas is formed between an inner surface of the vacuum insulation container and an outer surface of the hermetic structure, and
the gas-layer space communicates with the turbine chamber.

18. The turbine power generator according to claim 17, further comprising a baffle structure disposed in the suction container and located above the turbine machine.

19. The turbine power generator according to claim 18, wherein the baffle structure is disposed between the vacuum insulation lid and the turbine machine.

20. The turbine power generator according to claim 18, wherein the baffle structure comprises a baffle plate disposed between the turbine machine and the hermetic structure.

21. The turbine power generator according to claim 20, further comprising a discharge pipe coupled to a discharge outlet of the turbine machine, the discharge pipe extending through the vacuum insulation lid, and the baffle plate being fixed to the discharge pipe.

22. The turbine power generator according to claim 20, wherein the baffle plate is fixed to an inner surface of the vacuum insulation container.

23. The turbine power generator according to claim 20, wherein the baffle plate is located above a liquid surface of the liquefied gas in the vacuum insulation container.

24. The turbine power generator according to claim 20, wherein the baffle plate is located below a liquid surface of the liquefied gas in the vacuum insulation container.

25. The turbine power generator according to claim 18, wherein the baffle structure is fixed to the hermetic structure.

26. The turbine power generator according to claim 18, wherein the baffle structure comprises a labyrinth flow-path structure defining a labyrinth flow path.

27. A turbine power generator for generating electric power by utilizing fluid energy of liquefied gas, comprising:
a suction container having a suction port;
a turbine machine disposed in the suction container; and
a boil-off gas discharge pipe coupled to the suction container,
wherein the suction container includes:
a thermal insulation container; and
a vacuum insulation lid having a hermetic structure in which a vacuum is formed,
the turbine machine is disposed in a turbine chamber formed by the thermal insulation container and the vacuum insulation lid,
a gas-layer space for forming a gas insulation layer made of a boil-off gas is formed between an inner surface of the thermal insulation container and an outer surface of the hermetic structure,
the gas-layer space communicates with the turbine chamber, and
the boil-off gas discharge pipe opens in the suction container at a position lower than the gas-layer space.

28. The turbine power generator according to claim 27, wherein the boil-off gas discharge pipe is coupled to a side wall of the thermal insulation container at a position lower than the gas-layer space.

29. The turbine power generator according to claim 27, wherein the boil-off gas discharge pipe includes a first pipe and a second pipe extending upward from the first pipe, the first pipe being coupled to a side wall of the thermal insulation container at a position between the suction port and the gas-layer space.

30. The turbine power generator according to claim 27, wherein the vacuum insulation lid closes an upper opening of the thermal insulation container to form a dead-end space in an upper portion of the thermal insulation container that does not allow gas to escape.

31. The turbine power generator according to claim 27, wherein the boil-off gas discharge pipe extends through the vacuum insulation lid and protrudes downward from a bottom surface of the vacuum insulation lid.

32. The turbine power generator according to claim 27, wherein t the thermal insulation container comprises a vacuum insulation container having a double-wall structure in which a vacuum is formed.
